(19) United States
(12) Patent Application Publication
(10) Pub. No.: US 2011/0029469 A1
(43) Pub. Date: Feb. 3, 2011

(54) INFORMATION PROCESSING APPARATUS, INFORMATION PROCESSING METHOD AND PROGRAM

(76) Inventor: Hideshi YAMADA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/845,968

(22) Filed: Jul. 29, 2010

(30) Foreign Application Priority Data
Jul. 30, 2009 (JP) P2009-177580

(51) Int. Cl. G06F 15/18; G06F 17/10

(52) U.S. Cl. 706/14; 703/2

(57) ABSTRACT

An information processing apparatus, which performs setting of a mixture model function representing a mixture model along with adaptively adjusting the number of model components mixed in the mixture model, includes an acquisition section configured to acquire a first data sample and a second data sample, both of which are composed of multi-dimensions; a mixture-model-function generation section configured to generate a mixture model function on the basis of the first data sample; a mixture-model-function goodness-of-fit calculation section configured to calculate a goodness of fit for the mixture model function on the basis of the second data sample; and a mixture-model-function update section configured to update the mixture model function so as to adjust the number of model components mixed in a mixture model, which are represented by the mixture model function, on the basis of the goodness of fit for the mixture model function.

### BACKGROUND OF THE INVENTION

1. Field of the Invention

The present invention relates to information processing apparatuses, information processing methods and programs, and in particular, it relates to an information processing apparatus, an information processing method and a program, which make it possible to, when categorizing data by using a Gaussian mixture model which is set during the categorization, optimize the number of model mixture components mixed in the Gaussian mixture model.

2. Description of the Related Art

In general, processing, which enables establishing a mathematical model on the basis of given training data, and categorizing data, which is newly given, on the basis of the mathematical model, is called supervised learning processing.

Naturally, it is desirable that, when categorizing new data, the mathematical model, which establishes the supervised learning processing, includes a small amount of error relative to the given training data. Therefore, for example, in the case where a Gaussian mixture model is employed as a model, by increasing the number of mixed Gaussian functions, it is possible to reduce an amount of error.

Here, with respect to the number of mixed models (i.e., the number of mixed Gaussian functions), if the number of mixture components included in the Gaussian mixture model relative to given training data is less than an optimal value, the possibility of making an amount of fitting error be larger becomes higher. In contrast, if the number of mixture components is more than an optimal value, an overfitting condition occurs, so that generalization performance for new data becomes worse.

Therefore, it is desirable to provide an algorithm which enables establishment of a Gaussian mixture model, which includes a fitting error falling within an allowable range relative to given training data, and have appropriate generalization performance.

In methods for establishing Gaussian mixture models, an example of a calculation method using the expectation-maximization (EM) method is well known to those skilled in the art (refer to a non-patent document 1: Patten Recognition and Machine Learning (Information Science and Statistics), Springer, ISBN 0387310738). In this case, by giving a fixed number of mixture components included in a Gaussian mixture model as an input parameter in advance, it is possible to perform adjustment of the Gaussian mixture model.

Further, as a simple method, a method using the binary tree quantization principle is also well known to those skilled in the art (refer to a non-patent document 2: ORCHARD, M. T., AND BOUMAN, C. A. 1991. Color Quantization of Images. IEEE Transactions on Signal Processing 39, 12, 2677-2690). In this method, a Gaussian mixture model including a mixture component corresponding to sample data is given as an initial model, and the Gaussian mixture model is updated along with splitting the sample data into a plurality of clusters of data. That is, mixture components included in the Gaussian mixture model correspond to respective clusters, and processes, in which a cluster having a maximum eigenvalue is split into two clusters, and subsequently, Gaussian functions are calculated, are repeated until the number of the clusters comes to a predetermined number.

Further, as a method for determining whether a probabilistic model is appropriate, or not, the minimum description length method is well known to those skilled in the art (refer to a non-patent document 3: J. Rissanen, Modeling by Shortest Data Description, Automatica, Vol. 14, pp. 465. 471, 1978). In this calculation method, a determination is made as to whether a model is appropriate, or not, by estimating the sum of a bit length, which is necessary for erroneous identifications for sets of training sample data relating to identification rules to be described, and a bit length, which is necessary for complexity of models (identification rules) themselves to be described.

### SUMMARY OF THE INVENTION

However, in the method described in the above-described non-patent document 1, it is necessary to carefully select the number of Gaussian functions in advance so as to maintain appropriate generalization performance and fitting errors falling within a allowable range. Further, in this method, a Gaussian mixture model is established by repeating processes, in which, in two steps such as an expectation-step (E-step) and a maximization-step (M-step), goodness of fits for the Gaussian functions are calculated, and the Gaussian functions are further updated on the basis of the calculation result. Therefore, the established Gaussian mixture model is likely to vary according to the selection of initial values, and further, it is necessary to perform a considerable number of repeated calculations until the Gaussian mixture model comes to a convergent condition.

Further, in the methods described in the above-described non-patent documents 2 and 3, the estimation of models are performed after the fact, and thus, estimation results can be indexes, from which an optimal number of mixture components is learnt, but it is difficult to learn an optimal number of mixture components merely from input sample data.

Accordingly, it is desirable to provide an information processing apparatus, an information processing method and a program, which make it possible to, in particular, establish a high-accuracy Gaussian mixture model from two clusters of sample data at a high-speed.

An information processing apparatus according to an embodiment of the present invention, which performs setting of a mixture model function representing a mixture model along with adaptively adjusting the number of at least a model component mixed in the mixture model, includes an acquisition section configured to acquire a first data sample and a second data sample, both of which are composed of multi-dimensions; a mixture-model-function generation section configured to generate a mixture model function on the basis of the first data sample; a mixture-model-function goodness-of-fit calculation section configured to calculate a goodness of fit for the mixture model function on the basis of the second data sample; and a mixture-model-function update section configured to update the mixture model function so as to adjust the number of at least a model component mixed in a mixture model, which is represented by the mixture model function, on the basis of the goodness of fit for the mixture model function.

Preferably, the information processing apparatus according to the embodiment of the present invention can further include a goodness-of-fit determination section configured to, by comparing a goodness of fit for the mixture model function having been updated by the mixture-model-function update section, and a goodness of fit for the mixture model function before being updated, determine whether the goodness of fit for the mixture model function having been updated is within an allowable range, or not; and if it is determined by the goodness-of-fit determination section that the goodness of fit for the mixture model function having been updated is not within the allowable range, the information processing apparatus according to the embodiment of the present invention can cause the mixture-model-function update section to further update the mixture model function.

Preferably, the information processing apparatus according to the embodiment of the present invention can cause the mixture-model-function generation section to generate the mixture model function for the second data sample, in addition to the mixture model function for the first data sample; and can cause the mixture-model-function goodness-of-fit calculation section to, on the basis of likelihoods corresponding to respective mixture model functions for the first data sample and the second data sample, calculate the goodness of fit.

Preferably, the information processing apparatus according to the embodiment of the present invention can cause the mixture-model-function update section to update the mixture model function so as to perform adjustment of the number of at least a model component by splitting data forming a model component having the largest eigenvalue among the at least a model component mixed in the mixture model represented by the mixture model function.

Preferably, the information processing apparatus according to the embodiment of the present invention can further include a data inner product calculation section configured to obtain a data inner product by calculating an inner product between each piece of data, which is included in the first data sample and forms a model component having the largest eigenvalue among at least a model component which is mixed in the mixture model represented by the mixture model function, and an eigenvector for the each piece of data which forms the model component having the largest eigenvalue; an average inner product calculation section configured to obtain an average inner product by calculating an inner product between an average vector obtained from each piece of data, which is included in the first data sample and forms a model component having the largest eigenvalue among at least a model component which is mixed in the mixture model represented by the mixture model function, and an eigenvector for the each piece of data which forms the model component having the largest eigenvalue; and can cause the mixture-model-function update section configured to update the mixture model function so as to perform adjustment of the number of at least a model component by splitting the pieces of data forming the model component having the largest eigenvalue into two portions thereof in accordance with a magnitude relation between the data inner product and the average inner product.

Preferably, the information processing apparatus according to the embodiment of the present invention can cause the mixture-model-function goodness-of-fit calculation section to calculate a goodness of fit for each of at least a model-function component forming the mixture model function; and can cause the mixture-model-function update section to perform adjustment for at least a model-function component having a relatively low goodness of fit among the goodness of fit for each of the at least a model-function component.

An information processing apparatus according to another embodiment of the present invention, in which a mixture model function representing a mixture model is set along with adaptively adjusting the number of at least a mixture model component included in the mixture model, includes the steps of acquiring a first data sample and a second data sample, both of which are composed of multi-dimensions; generating a mixture model function on the basis of the first data sample; calculating a goodness of fit for the mixture model function on the basis of the second data sample; and updating the mixture model function so as to adjust the number of at least a model component mixed in a mixture model, which is represented by the mixture model function, on the basis of the goodness of fit for the mixture model function.

A program according to another embodiment of the present invention causes a computer, which performs control so as to cause an information processing apparatus to perform setting of a mixture model function representing a mixture model along with adaptively adjusting the number of at least a mixture model component included in the mixture model, to execute processing including the steps of acquiring a first data sample and a second data sample, both of which are composed of multi-dimensions; generating a mixture model function on the basis of the first data sample; calculating a goodness of fit for the mixture model function on the basis of the second data sample; and updating the mixture model function so as to adjust the number of at least a model component mixed in a mixture model, which is represented by the mixture model function, on the basis of the goodness of fit for the mixture model function.

According to another embodiment of the present invention, a first data sample and a second data sample, both of which are composed of multi-dimensions, are acquired; a mixture model function is generated on the basis of the first data sample; a goodness of fit for the mixture model function is calculated on the basis of the second data sample; and the mixture model function is updated so that the number of at least a model component mixed in a mixture model, which is represented by the mixture model function, can be adjusted on the basis of the goodness of fit for the mixture model function.

According to an embodiment of the present invention, it is possible to establish a Gaussian mixture model having a optimal number of model components from two clusters of sample data.

### BRIEF DESCRIPTION OF THE DRAWINGS

FIG. 1 is a diagram illustrating an example of a configuration of a Gaussian mixture model creation apparatus according to an embodiment to which the present invention is applied;

FIG. 2 is a diagram illustrating an example of a configuration of a Gaussian mixture model update unit shown in FIG. 1, according to an embodiment of the present invention;

FIG. 3 is a flowchart illustrating Gaussian mixture model creation processing according to an embodiment of the present invention;

FIG. 4 is a flowchart illustrating Gaussian mixture model update processing according to an embodiment of the present invention;

FIG. 5 is a diagram illustrating Gaussian mixture model update processing according to an embodiment of the present invention; and

FIG. 6 is a diagram illustrating an example of a configuration of a general-purpose personal computer.

### DESCRIPTION OF THE PREFERRED EMBODIMENTS

### [An Example of a Configuration of a Gaussian Mixture Model Creation Apparatus]

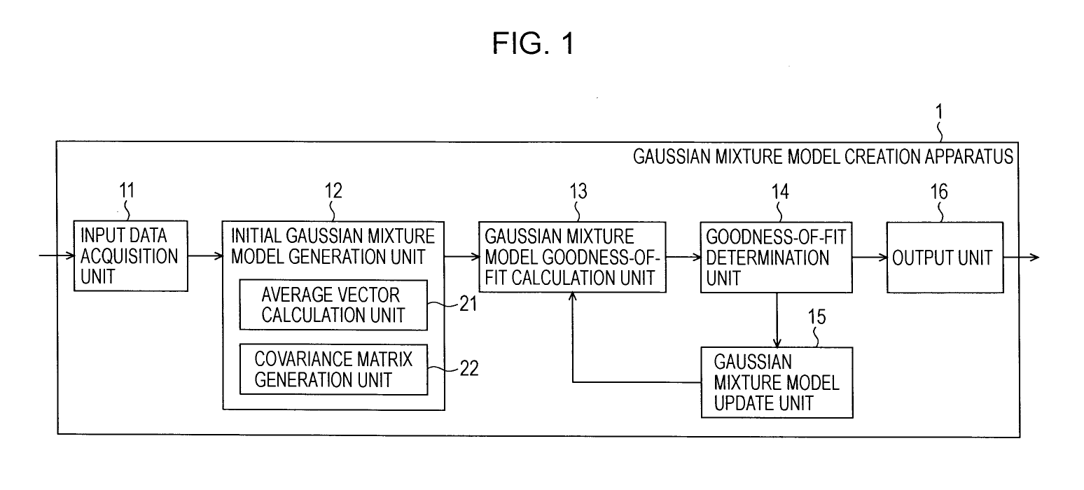

FIG. 1 is a diagram illustrating an example of a configuration of a Gaussian mixture model creation apparatus according to an embodiment, to which the present invention is applied.

A Gaussian mixture model creation apparatus 1 shown in FIG. 1 is configured to, for two classes of input data samples, by performing adjustment so as to obtain an optimal number of mixture components (an optimal number of models), create a function representing a Gaussian mixture model. The function representing a Gaussian mixture model is configured by linearly combining Gaussian functions, which are set individually for each of models corresponding to respective mixture components, the number of the Gaussian functions being equal to the number of the models.

Therefore, hereinafter, a Gaussian mixture model function will be termed just a Gaussian mixture model, and a Gaussian function representing each model, i.e., each mixture component, will be also termed just a model. Therefore, creating a Gaussian mixture model is equivalent to fixing a Gaussian mixture model function by setting parameters for specifying the Gaussian mixture model function. Further, the parameters for specifying the Gaussian mixture model function are, for example, a covariance matrix, an average vector, an eigenvalue and an eigenvector, and these parameters will be hereinafter termed Gaussian parameters.

The Gaussian mixture model creation apparatus 1 is configured to include an input data sample acquisition unit 11, an initial Gaussian mixture model generation unit 12, a Gaussian mixture model goodness-of-fit calculation unit 13, a goodness-of-fit determination unit 14, a Gaussian mixture model update unit 15 and an output unit 16.

The input data sample acquisition unit 11 acquires a first group of data samples, which is to be a group of input data for a desired mixture model, and a second group of data samples, which is to be a group of data desired to be categorized into a class different from a class including the first group of data samples, and supplies the first and second groups of data samples to the initial Gaussian mixture model generation unit 12. With respect to the first and second groups of data samples, for example, a group of data samples including object images (foreground images) and a group of data samples including background images can be provided, respectively. In addition, hereinafter, processes performed in the case where, as the first and second groups of data samples, a group of data samples including object images and a group of data samples including background images are used, respectively, will be described, but obviously, groups of data samples other than such groups of data samples can be used.

The initial Gaussian mixture model generation unit 12 is configured to include an average vector calculation unit 21 and a covariance matrix generation unit 22. The initial Gaussian mixture model generation unit 12 performs control so as to cause the average vector calculation unit 21 to calculate an average vector by handling the first group of data samples, which is supplied from the input data sample acquisition unit 11, as a first cluster. Further, the initial Gaussian mixture model generation unit 12 performs control so as to cause the covariance matrix generation unit 22 to calculate a covariance matrix by handling the first group of data samples, which is supplied from the input data sample acquisition unit 11, as a first cluster. Further, the initial Gaussian mixture model generation unit 12 is configured to, on the basis of the calculated average vector and covariance matrix, generate an initial Gaussian mixture model p(x) for the first group of data samples. Further, the initial Gaussian mixture model generation unit 12 supplies the generated Gaussian mixture model p(x), the first and second groups of data samples, and information relating to a group of clusters to the Gaussian mixture model goodness-of-fit calculation unit 13.

In addition, hereinafter, this Gaussian mixture model function p(x) will be termed just a Gaussian mixture model p(x).

The Gaussian mixture model goodness-of-fit calculation unit 13 calculates a goodness of fit for the Gaussian mixture model supplied from the initial Gaussian mixture model generation unit 12 or the Gaussian mixture model update unit 15, and supplies the goodness-of-fit determination unit 14 with the calculated goodness of fit for the Gaussian mixture model together with the first and second groups of data samples. At this time, the Gaussian mixture model goodness-of-fit calculation unit 13 also supplies the goodness-of-fit determination unit 14 with information relating to a group of clusters together therewith.

The goodness-of-fit determination unit 14 stores therein the goodness of fit supplied from the Gaussian mixture model goodness-of-fit calculation unit 13 as a current goodness of fit eₜ, and determines whether the current Gaussian mixture model is necessary to be further updated, or not, by comparing a difference absolute value with a threshold value, which is calculated from the current goodness of fit eₜ and a goodness of fit e₍ₜ₋₁₎ for a Gaussian mixture model immediately prior to update of the current Gaussian mixture model. Further, the goodness-of-fit determination unit 14 is configured to, in the case where there is no change between the current goodness of fit eₜ and the immediately previous goodness of fit e₍ₜ₋₁₎, output the current Gaussian mixture model p(x) to the output unit 16. In contrast, in the case where there is any change between the current goodness of fit eₜ and the immediately previous goodness of fit e₍ₜ₋₁₎, so that the Gaussian mixture model p(x) is necessary to be further updated, the goodness-of-fit determination unit 14 supplies the Gaussian mixture model update unit 15 with the current Gaussian mixture models p(x), and further, directs the Gaussian mixture model update unit 15 to update the current Gaussian mixture model p(x). At this time, the goodness-of-fit determination unit 14 also supplies the Gaussian mixture model update unit 15 with the first and second groups of data samples and information relating a group of clusters together with the Gaussian mixture models p(x).

The Gaussian mixture model update unit 15 selects a Gaussian function and a cluster, which correspond to one specific model, from among the Gaussian mixture model p(x) and the group of clusters supplied from the goodness-of-fit determination unit 14, respectively. Further, the Gaussian mixture model update unit 15 updates the Gaussian mixture model by splitting the selected Gaussian function and the selected cluster into two Gaussian functions and two clusters, and replacing the selected Gaussian function and the selected cluster by the two split Gaussian functions and the two split clusters, respectively. Further, the Gaussian mixture model update unit 15 supplies the Gaussian mixture model and the group of clusters having been updated to the Gaussian mixture model goodness-of-fit calculation unit 13.

More circumstantially, firstly, the Gaussian mixture model update unit 15 is configured to, from among Gaussian functions each forming a model, select one Gaussian function Nₘ(x) in accordance with a predetermined condition, and split a cluster corresponding to the selected Gaussian function Nₘ(x) into two clusters. Here, m denotes an index to identify the selected model. Further, the Gaussian mixture model update unit 15 newly obtains Gaussian functions Nₘ₁(x) and Nₘ₂(x) corresponding to respective two clusters having been split, and updates the Gaussian mixture model p₍ₜ₎(x) into p₍ₜ₊₁₎(x) by replacing the selected Gaussian function Nₘ(x) by the two Gaussian functions Nₘ₁(x) and Nₘ₂(x). Further, at the same time, the Gaussian mixture model update unit 15 also updates the cluster corresponding to the selected Gaussian function Nₘ(x) into the two split clusters. Here, m1 and m2 denote indexes to identify respective two clusters resulting from splitting a cluster represented by the model m.

### [Regarding a Gaussian Model Update Unit]

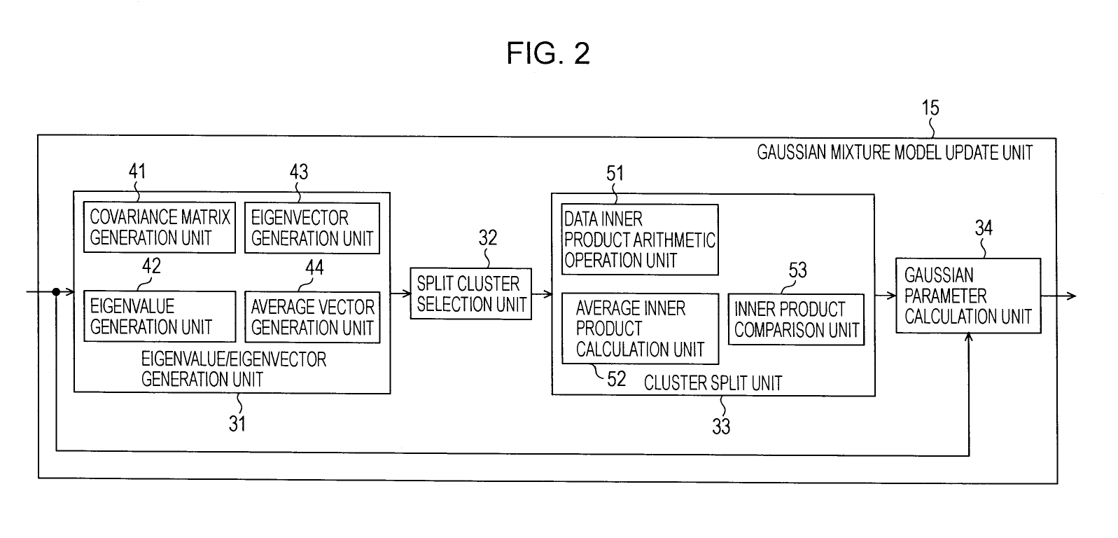

Next, an example of a configuration of the Gaussian mixture model update unit 15 will be described below with reference to FIG. 2.

The Gaussian mixture model update unit 15 is configured to include an eigenvalue/eigenvector generation unit 31, a split cluster selection unit 32, a cluster split unit 33 and a Gaussian parameter calculation unit 34.

The eigenvalue/eigenvector generation unit 31 is configured to include a covariance matrix generation unit 41, an eigenvalue generation unit 42, an eigenvector generation unit 43 and an average vector generation unit 44.

The eigenvalue/eigenvector generation unit 31 performs control so as to cause the covariance matrix generation unit 41 to generate a covariance matrix for each of clusters supplied from the goodness-of-fit determination unit 14. The eigenvalue/eigenvector generation unit 31 performs control so as to cause the eigenvalue generation unit 42 and the eigenvector generation unit 43 to generate an eigenvalue and an eigenvector from the covariance matrix having been generated for each cluster. Further, the eigenvalue/eigenvector generation unit 31 performs control so as to cause the average vector generation unit 44 to, with respect to the first group of data samples, generate an average vector for each cluster.

The eigenvalue/eigenvector generation unit 31 calculates a covariance matrix, an average vector, an eigenvalue and an eigenvector for each cluster, and supplies these to the split cluster selection unit 32. At this time, in the case of multi-dimensions, i.e., D dimensions, eigenvalues whose number is D are obtained for each cluster, and thus, the eigenvalue/eigenvector generation unit 31 selects a maximum eigenvalue from among the obtained eigenvalues for each cluster as an eigenvalue for the cluster.

The split cluster selection unit 32 selects an eigenvalue having a maximum value from among the eigenvalues for respective clusters, which have been supplied from the eigenvalue/eigenvector generation unit 31, selects a cluster corresponding to the selected eigenvalue, and supplies the cluster split unit 33 with the selected cluster, and an eigenvector and an average vector corresponding to the selected cluster.

The cluster split unit 33 is configured to include a data inner product arithmetic operation unit 51, an average inner product calculation unit 52 and an inner product comparison unit 53. The cluster split unit 33 is configured to, on the basis of the cluster, the average vector and the eigenvector having been supplied from the split cluster selection unit 32, split sample data forming the cluster into two clusters of sample data, and outputs the two clusters to the Gaussian parameter calculation unit 34.

The Gaussian parameter calculation unit 34 calculates a Gaussian parameter (μ, Σ) and a weight G for each of the two clusters having been supplied from the cluster split unit 33, and outputs the Gaussian mixture model and the group of clusters having been updated. Here, μ and Σ denote an average vector and a covariance matrix, respectively. The weight G for each cluster is obtained, for example, by calculating a ratio of the number of data samples for the cluster relative to the total number of data samples.

The output unit 16 outputs the Gaussian mixture model as a result of processing, which has been supplied from the goodness-of-fit determination unit 14.

### [Regarding Gaussian Mixture Model Creation Processing]

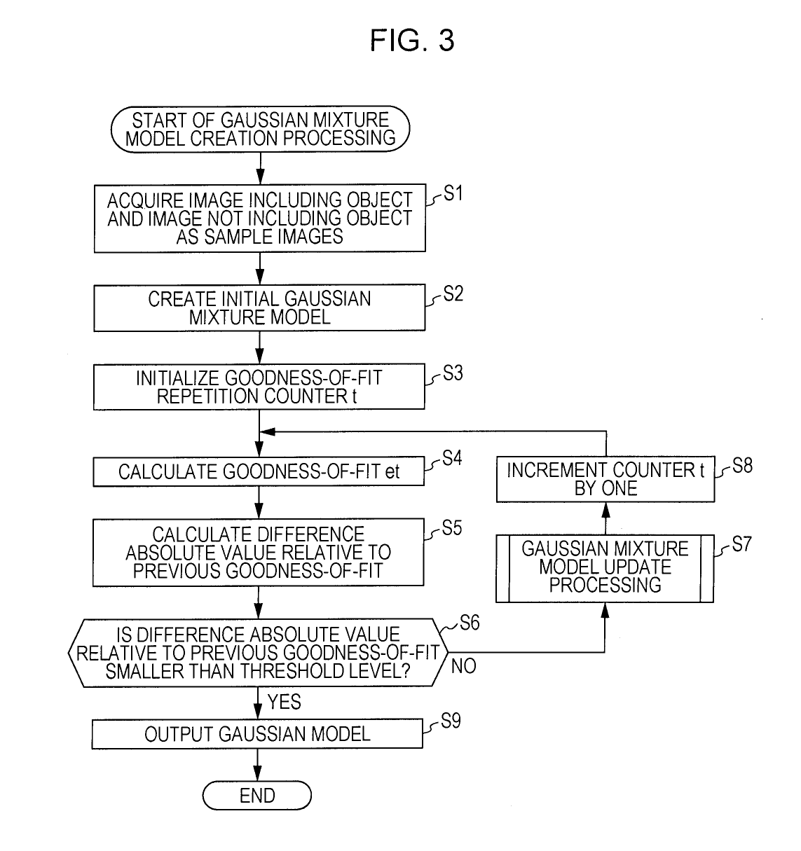

Next, Gaussian model creation processing will be described below with respect to a flowchart shown in FIG. 3.

In step S1, the input data sample acquisition unit 11 acquires sample data for images of an object as a first group of data samples, and sample data for images of targets other than the object, that is, sample data for background images, as a second group of data samples. Further, the input data sample acquisition unit 11 supplies the acquired sample data for images of an object and the acquired sample data for background images to the initial Gaussian mixture model generation unit 12.

In step S2, the initial Gaussian mixture model generation unit 12 performs control so as to cause the average vector calculation unit 21 to calculate an average vector by handling the first group of data samples having been supplied from the input data sample acquisition unit 11 as a first cluster. Further, the initial Gaussian mixture model generation unit 12 performs control so as to cause the covariance matrix generation unit 22 to calculate a covariance matrix by handling the first group of data samples having been supplied from the input data sample acquisition unit 11 as a first cluster. Further, the initial Gaussian mixture model generation unit 12 generates a Gaussian mixture model p(x) for the first group of data samples on the basis of the average vector and the covariance matrix having been calculated in the above-described processing.

Here, as represented by the following formula (1), when data x of D dimensions is given, the Gaussian mixture model function p(x) is a function representing a likelihood relating to the data x. More specifically, the Gaussian mixture model function p(x) is a summation of functions whose number is K, each resulting from multiplying a Gaussian function N(x|μₖ, Σₖ) of D dimensions by a weight Gₖ (k is an index, and k=1, 2, . . . K).

$$p ( x ) = {\sum }_{k = 1}^{K} {G}_{k} N ( x \vert {μ}_{k} , {Σ}^{k} ) \qquad ( 1 )$$

Here, as represented by the following formula (2), when data x of D dimensions, which is categorized in accordance with the index k, is given, the Gaussian function N(x) is a function representing a likelihood of a Gaussian model relating to the data x of D dimensions, which is categorized in accordance with the index k, by using an average vector μₖ, the inverse matrix Σₖ⁻¹ of a covariance matrix Σₖ and the matrix formula |Σₖ| of the covariance matrix Σₖ.

$$N ( x \vert μ , Σ ) = \frac{1}{{( 2 π )}^{D / 2}} \frac{1}{{\vert \sum \vert}^{1 / 2}} exp \{ - \frac{1}{2} {( x - μ )}^{T} {Σ}^{- 1} ( - μ ) \} \qquad ( 2 )$$

In step S3, the Gaussian mixture model goodness-of-fit calculation unit 13 initializes a goodness-of-fitness repetition counter t, which is omitted from illustration.

In step S4, the Gaussian mixture model goodness-of-fit calculation unit 13 calculates a goodness of fit eₜ from a likelihood, which is obtained in the case where the first group of data samples is given to the Gaussian mixture model p(x), and a likelihood, which is obtained in the case where the second group of data samples is given to the Gaussian mixture model p(x), the Gaussian mixture model p(x) having been supplied from the initial Gaussian mixture model generation unit 12 or the Gaussian mixture model update unit 15, and supplies the calculated goodness-of-fitness eₜ to the goodness-of-fit determination unit 14. More circumstantially, the Gaussian mixture model goodness-of-fit calculation unit 13 obtains the goodness of fit eₜ by using the following formula (3).

$${e}_{t} = \frac{{\sum }_{j = 0}^{m} p ( {y}_{i} )}{{\sum }_{i = 0}^{n} p ( {x}_{i} )} \qquad ( 3 )$$

That is, the goodness of fit eₜ is an index indicating a ratio of the sum of a second likelihood resulting from applying a Gaussian mixture model to a second data sample yⱼ relative to the sum of a first likelihood resulting from applying the Gaussian mixture model to a first data sample xᵢ. Therefore, this goodness of fit eₜ is an index indicating the degree of accuracy for categorization of data samples. Here, the counter t is an index indicating the number of repetition of processing for updating the Gaussian mixture model p(x).

In step S5, the goodness-of-fit determination unit 14 calculates a difference absolute value between a current goodness of fit and an immediately previous goodness of fit, and in step S6, by comparing the calculated difference absolute value with a threshold value, determines whether the goodness of fit has converged so sufficiently that it is unnecessary to further update the Gaussian mixture model p(x), or not.

More circumstantially, as represented by the following formula (4), by determining whether a variation amount (|eₜ−e₍ₜ₋₁₎|, which is a difference absolute value between the goodness of fit eₜ for the current Gaussian mixture model pₜ(x) and the goodness of fit e₍ₜ₋₁₎ for the immediately previous Gaussian mixture model p₍ₜ₋₁₎(x), is smaller than a predetermined threshold value, or not, the goodness-of-fit determination unit 14 determines whether the goodness of fit has converged sufficiently, or not.

|eₜ−e₍ₜ₋₁₎|<threshold (4)

In addition, in initial processing, since the immediately previous goodness of fit does not exist, for convenience of calculation, for example, a minimum value of the goodness of fit is set as the immediately previous goodness of fit.

In step S6, if the variation amount is not smaller than the predetermined value, the process flow proceeds to step S7. In step S7, the goodness-of-fit determination unit 14 causes the Gaussian mixture model update unit 15 to update the Gaussian mixture model pₜ(x) into the Gaussian mixture model p₍ₜ₊₁₎(x). At this time, the goodness-of-fit determination unit 14 stores the Gaussian mixture model pₜ(x) therein. In response thereto, the Gaussian mixture model update unit 15 executes Gaussian mixture model update processing, and thereby, updates a current, that is, a t-th Gaussian mixture model pₜ(x) corresponding to a value t of the counter t into the Gaussian mixture model p₍ₜ₊₁₎(x).

### [Regarding Gaussian Mixture Model Update Processing]

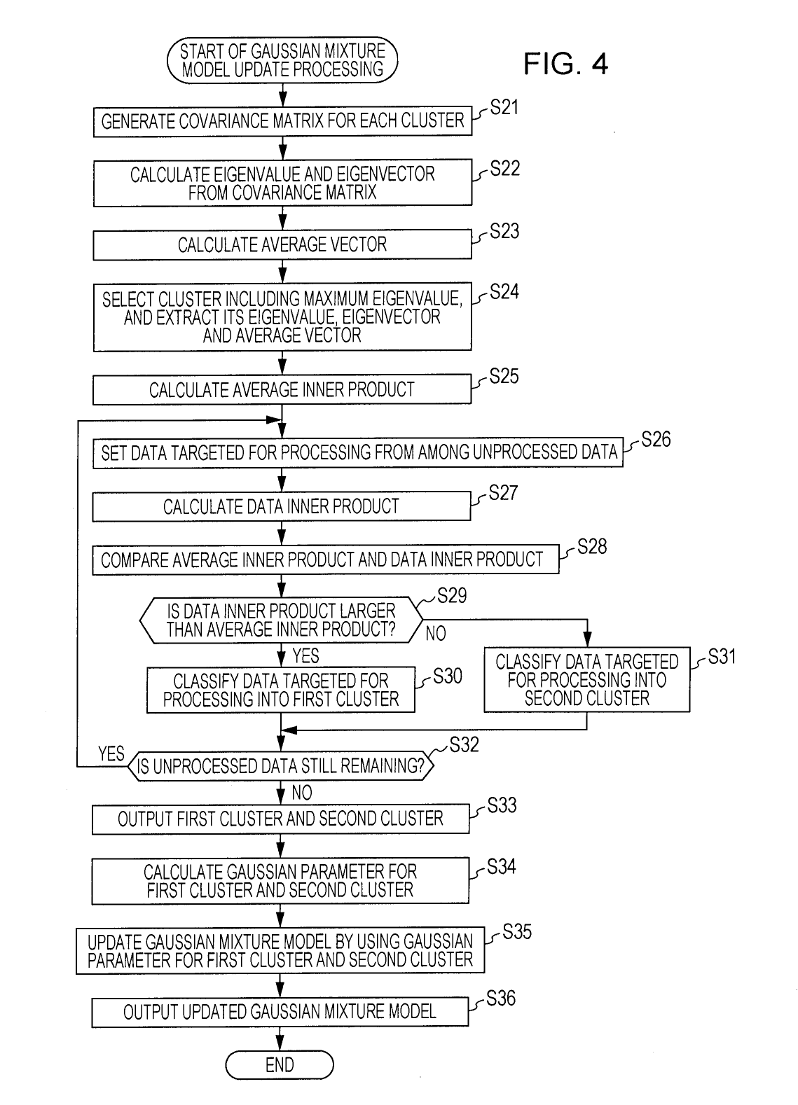

Here, Gaussian mixture model update processing will be described below with reference to a flowchart shown in FIG. 4.

In step S21, the eigenvalue/eigenvector generation unit 31 performs control so as to cause the covariance matrix generation unit 41 to generate covariance matrixes for all of clusters.

In step S22, the eigenvalue/eigenvector generation unit 31 performs control so as to cause the eigenvalue generation unit 42 to generate an eigenvalue from the covariance matrix for each of the clusters. Moreover, the eigenvalue/eigenvector generation unit 31 performs control so as to cause the eigenvector generation unit 43 generate an eigenvector for each of the clusters on the basis of the generated eigenvalue.

In step S23, the eigenvalue/eigenvector generation unit 31 performs control so as to cause the average vector generation unit 44 to generate an average vector for the covariance matrix for each of the clusters.

In step S24, the eigenvalue/eigenvector generation unit 31 supplies groups of the covariance matrix, the eigenvalue, the eigenvector and the average vector, which have been generated for respective clusters, to the split cluster selection unit 32. The split cluster selection unit 32 selects a group of the covariance matrix, the eigenvalue, the eigenvector and the average vector corresponding to a cluster, the group corresponding to the cluster including the largest eigenvalue among the groups of the covariance matrix, the eigenvalue, the eigenvector and the average vector, which have been generated for respective clusters. Further, the eigenvalue/eigenvector generation unit 31 extracts the selected group of the covariance matrix, the eigenvalue, the eigenvector and the average vector, the group including the largest eigenvalue among the groups having been generated for respective clusters, and supplies the extracted group of the covariance matrix, the eigenvalue, the eigenvector and the average vector to the split cluster selection unit 32 together with sample data included in the selected cluster.

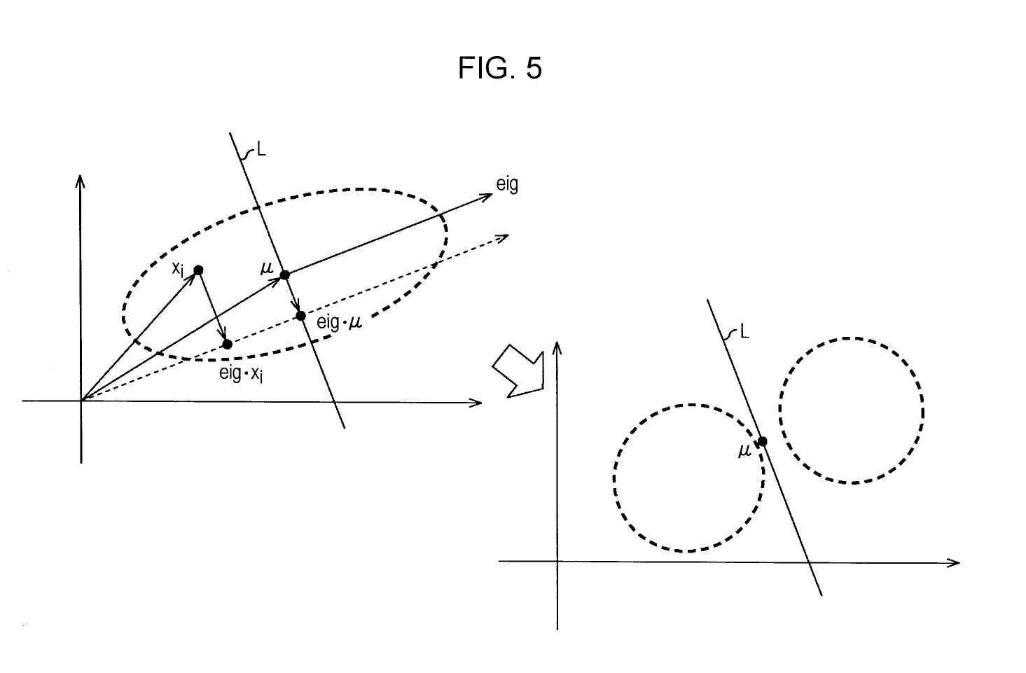

In step S25, the cluster split unit 33 performs control so as to cause the average inner product calculation unit 52 to calculate an average inner product eig·μ, which is an inner product of an average vector μ and an eigenvector eig. The average vector μ, the eigenvector eig and the average inner product eig·μ have mutual relationships, such as shown in an upper-left portion of FIG. 5. That is, the average inner product eig·μ represents a multiple number of a component of the average vector μ, the component extending in the dot-line direction which is shifted in parallel with the eigenvector eig, relative to the eigenvector, the average vector μ existing within a cluster, which is represented by a dot-line ellipse and has been selected as a cluster, which corresponds to a group of a covariance matrix, an eigenvalue, an eigenvector and an average vector, the group including the largest eigenvalue among the groups having been generated for respective clusters.

In step S26, the cluster split unit 33 sets unprocessed sample data, which is selected from among sample data included in the cluster having been supplied from the split cluster selection unit 32, as data xᵢ targeted for processing.

In step S27, the cluster split unit 33 performs control so as to cause the data inner product calculation unit 51 to calculate a data inner product eig·xᵢ, which is an inner product of data xᵢ and an eigenvector eig. The data xᵢ, the eigenvector eig and the data inner product eig·xᵢ have mutual relationships, such as shown in an upper-left portion of FIG. 5. That is, the average inner product eig·xᵢ represents a multiple number of a component of the data xᵢ, the component extending in the dot-line direction which is shifted in parallel with the eigenvector eig, relative to the eigenvector, the data xᵢ existing within a cluster which is represented by a dot-line ellipse and has been selected as a cluster corresponding to a group of a covariance matrix, an eigenvalue, an eigenvector and an average vector, the group including the largest eigenvalue among the groups having been generated for respective clusters.

In step S28, the cluster split unit 33 performs control so as to cause the inner product comparison unit 53 to compare a magnitude relation between the data inner product and the average inner product by performing an arithmetic operation using the following formula (5).

eig·xᵢ>eig·μ (5)

In step S29, the cluster split unit 33 determines whether the magnitude of the data inner product is larger than that of the average inner product, or not, on the basis of the result of comparison performed by the inner product comparison unit 53, and for example, if the magnitude of the data inner product is larger than that of the average inner product, in step S30, the cluster split unit 33 categorizes the data xᵢ into the first cluster, and then, causes the process flow to proceed to step S32.

In contrast, in step S29, if the magnitude of the data inner product is not larger than that of the average inner product, in step S31, the cluster split unit 33 categorizes the data xᵢ into the second cluster.

In step S32, the cluster split unit 33 determines whether unprocessed data exists, or not, and if it is determined that the unprocessed data exists, the cluster split unit 33 causes the process flow to return to step S26. That is, the processes from step S26 to the step S32 are repeated until it is determined that no unprocessed data exists. Further, if it is determined in step S32 that no unprocessed data exists, the process flow proceeds to step S33.

The concept of this processing is such that, as shown in the upper-left portion of FIG. 5, among sample data forming a cluster, sample data, which is located in an area stretching in a direction towards an original point from a straight line L, which passes through the end position of the average vector μ and extends in a direction perpendicular to the direction of the eigenvector eig, has a data inner product smaller than an average inner product, and thus, the sample data is categorized into the second cluster. In contrast, sample data, which is located in an area stretching in a direction opposite the original point from the straight line L, has a data inner product larger than an average inner product, and thus, the sample data is categorized into the first cluster. As a result of such processing as described above, as shown in the lower-right portion of FIG. 5, the selected cluster is split into two clusters by the straight line L, one being the first cluster, into which sample data located in an area stretching in a direction opposite the original point is categorized, the other one being the second cluster, into which sample data located in a remaining area stretching in a direction towards the original point is categorized.

In step S33, the cluster split unit 33 supplies the obtained first and second clusters to the Gaussian parameter calculation unit 34.

In step S34, on the basis of sample data included in the first cluster and the second cluster, the Gaussian parameter calculation unit 34 generates Gaussian functions, and calculates Gaussian parameters therefor.

In step S35, the Gaussian parameter calculation unit 34 updates the Gaussian mixture model by using the calculated Gaussian parameters for the two clusters. That is, the Gaussian parameter calculation unit 34 updates the Gaussian mixture model by replacing a Gaussian model corresponding to the cluster having been selected as a cluster including a maximum eigenvalue by two Gaussian models corresponding to the respective two clusters resulting from splitting the cluster, and mixing the two Gaussian models corresponding to the respective two clusters.

In step S36, the Gaussian parameter calculation unit 34 supplies the updated Gaussian mixture model to the Gaussian mixture model goodness-of-fit calculation unit 13.

That is, in the Gaussian mixture model update processing, eigenvalues are calculated for respective clusters, a cluster of sample data including a maximum eigenvalue is split into two clusters of sample data, and further, the Gaussian mixture model is updated by using Gaussian models, which correspond to the two split clusters, respectively. The eigenvalue and the eigenvector for each of the two clusters indicate an amount of variation and a direction of variation for data included therein, respectively. Therefore, it is possible to optimize Gaussian models, which are components forming a Gaussian mixture model, by newly setting two clusters resulting from splitting a cluster having a maximum eigenvalue in a direction perpendicular to the direction of an eigenvector, calculating Gaussian models corresponding to the respective two clusters, and replacing a Gaussian model corresponding the cluster having a maximum eigenvalue by the Gaussian models corresponding to the respective two clusters.

Here, the description is retuned to the flowchart shown in FIG. 3.

Subsequent to completion of the Gaussian mixture model update processes performed in step 7, the Gaussian model goodness-of-fit calculation unit 13 increments the repetition counter t by one in step 8, which is omitted from illustration, and causes the process flow to return to step S4.

In step S4, by using the above-described formula (3), the Gaussian mixture model goodness-of-fit calculation unit 13 calculates a goodness of fit e₍ₜ₊₁₎ from a likelihood resulting from applying the first group of data samples to the updated Gaussian mixture model p₍ₜ₊₁₎(x) and a likelihood resulting from applying the second group of data samples to the updated Gaussian mixture model p₍ₜ₊₁₎(x), and supplies the resultant goodness of fit e₍ₜ₊₁₎ to the goodness-of-fit determination unit 14.

In step S5, the goodness-of-fit determination unit 14 calculates a difference absolute value between the current goodness of fit e₍ₜ₊₁₎ and the immediately previous goodness of fit eₜ, and by comparing the calculated difference absolute value with a threshold value, determines whether the goodness of fit has converged so sufficiently that it is unnecessary to further update the Gaussian mixture model p₍ₜ₊₁₎(x), or not. If the difference absolute value between the current goodness of fit e₍ₜ₊₁₎ and the immediately previous goodness of fit eₜ is not smaller than the threshold value, the processes from step S4 to step S8 are repeatedly executed until the difference absolute value is smaller than the threshold value. Every time the processes from step S4 to S8 are executed, that is, every time the update processing is executed, one cluster is increased, and as a result, a goodness of fit is obtained every time one cluster is increased. Further, in step S6, if a difference absolute value between a current goodness of fit and an immediately previous goodness of fit is smaller than the threshold value, so that it is unnecessary to make the number of components be more than a current number of components, that is, it is unnecessary to update a current Gaussian mixture model into a Gaussian mixture model having more clusters than the current Gaussian mixture model, the process flow proceeds to step S9.

In step S9, the goodness-of-fit determination unit 14 outputs a function forming a Gaussian mixture model as of then to the output unit 16. The output unit 16 outputs the function forming the Gaussian mixture model as of then.

Performing the above-described processing enables setting a Gaussian mixture model including Gaussian functions whose number is sequentially increased along with splitting a cluster having a large eigenvalue, and thus, enables preventing occurrence of fitting errors.

Further, the above-described processing is performed so that a goodness of fit for a Gaussian mixture model is set on the basis of likelihoods for the first group of data samples, and the second group of data samples other than data samples included in the first group, and every time a Gaussian function is increased, it is determined from a difference absolute value between a current goodness of fit and an immediately previous goodness of fit whether a variation of the goodness of fit is sufficiently small, or not, and if it is determined that the variation of the goodness of fit is sufficiently small, addition of a Gaussian function is halted. As a result, it is possible to increase the number of mixture components without increasing the number of Gaussian functions excessively, that is, along with maintaining generalization performance to some extent.

In any case, as a result, it is possible to perform high-speed setting of a optimal Gaussian mixture model.

In addition, in the above-described embodiment, it is determined whether a goodness of fit has converged, or not, by comparing a current goodness of fit with an immediately previous goodness, but, since it is desired that the goodness of fit comes to a value having some degree of certainty, it may be determined whether the current goodness of fit itself is smaller than a threshold value, or not.

Moreover, since it is also desired to limit the number of Gaussian model components, i.e., the number of clusters, besides the determination which is made on the basis of the goodness of fit, by providing an upper limit and a lower limit of the number of the Gaussian model components, it may be determined whether a Gaussian mixture model is to be further updated, or not, on the basis of the upper and lower limits of the number of the Gaussian model components.

Further, the explanation has been made so far by using an example in which two classes of data samples are provided, but this embodiment can be also applied to a case in which multi-classes, i.e., three or more classes of data samples are provided. That is, upon receipt of input multi-classes of data samples, the input data sample acquisition unit 11 may perform processing in the same procedure as described above by handling the input multi-classes of data samples as a first group of data samples, and a second group of data samples including data samples other than those included in the first group.

Further, in this embodiment, a method, in which a Gaussian model is created from two classes of data samples, is provided, but two Gaussian models may be created at a time.

That is, the two Gaussian models can be obtained in the same procedure as described above merely by interchanging the first group of data samples and the second group of data samples each other.

Further, by causing the goodness-of-fit determination unit 14 to buffer a pair of two goodness-of-fits having been calculated from two Gaussian models in advance, it may be determined whether a Gaussian mixture model is to be further updated, or not. In this case, processing may be performed so that a Gaussian model having a larger value of the goodness of fit, which is represented by the formula (3), is selected, and only the selected Gaussian model is updated. Further, it is not separately determined from respective goodness of fits whether the two Gaussian models are to be updated, or not, but it may be determined at a time from a result of comparing the total amount of the two goodness of fits with a threshold value whether the two Gaussian models are to be updated, or not.

Further, in this embodiment, the Gaussian mixture model update unit 15 updates the Gaussian mixture model by using a so-called binary tree quantization algorithm, but may update the Gaussian mixture model by using a method based on the above-described EM method. That is, in this case, it takes a relatively large amount of time for the Gaussian mixture model to be converged sufficiently, but it is possible to set a higher-accuracy Gaussian mixture model by sequentially calculating the Gaussian mixture model along with increasing the number of components included therein.

Further, in the above-described method, processing has been performed so that a cluster including a maximum is selected as a cluster to be split, but the cluster to be split may be selected in accordance with a goodness of fit for each of Gaussian functions which are components included in the Gaussian mixture model. That is, by obtaining goodness of fits for respective Gaussian functions included in a Gaussian mixture model in advance, and further, splitting and updating Gaussian functions each having a relatively lower goodness of fit among the Gaussian functions with a high priority, it is possible to increase the accuracy of the Gaussian mixture model. This method enables improvement of separation performance to a greater degree even if this method allows a Gaussian mixture model to be slightly unmatched with the distribution of input data samples.

Further, the input data sample acquisition unit 11 may calculate Gaussian models by subsampling the received two classes of data samples. That is, subsampling of the data samples reduces an amount of data to be processed, and thus, enables realization of increasing a processing speed and reducing the size of used memory.

Further, not by using the goodness-of-fit calculating method represented by the formula (3), but by using methods well known to those skilled in the art, such as a method using the minimum description length (MDL) principle (refer to the above-described non-patent document 3) and a method using Alaraike's Information Criteria (AIC) (refer to Alalai, Hitotugue (1974). “A new look at the statistical model identification”, IEEE Transactions on Automatic Control 19 (6): 716?723. doi: 10. 1109/TAC. 1974. 1100705. MR0423716), the goodness of fit may be calculated, and thereby, it is possible to increase the accuracy of determination to a greater degree.

By the way, a series of processes having been described so far can be executed by using hardware, but by using software. In the case where the series of processes is executed by using software, individual programs included in the software are installed from a recording medium into two types of computers, one being a computer, which is incorporated in dedicated hardware, the other one being a computer, which is capable of executing various kinds of functions by installing various kinds of programs thereinto, such as a general-purpose personal computer.

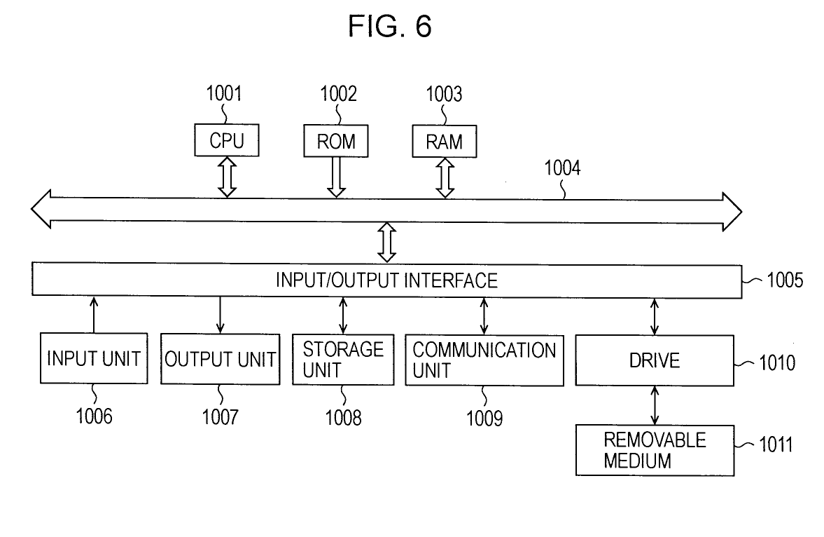

FIG. 6 illustrates an example of a configuration of a general-purpose personal computer. This personal computer incorporates a central processing unit (CPU) 1001. To the CPU 1001, an input/output interface 1005 is connected via a bus 1004. To the bus 1004, a read only memory (ROM) 1002 and a random access memory (RAM) 1003 are connected.

To the input/output interface 1005, an input unit 1006 configured to include input devices for inputting operation commands entered by users, such as a keyboard and a mouse device, an output unit 1007 configured to output processing and operation display screens and images resulting from performing processes to display devices, a storage unit 1008 configured to include devices for storing programs and various pieces of data therein, such as a hard disk drive, a communication unit 1009 configured to include a local area network (LAN) adapter and the like, and execute communication processing via networks as typified by the Internet. Further, to the input/output interface 1005, a drive 1010, which is configured to read and write data from/to a removable medium 1011, such as a magnetic disk (including a flexible disk), an optical disk (including a compact disc-read only memory (CD-ROM)), a digital versatile disc (DVD), or a semiconductor memory, is connected.

The CPU 1001 executes various kinds of processes in accordance with programs, which are stored in the ROM 1002, or in accordance with programs, which are read out from the removable medium 1011, such as a semiconductor memory, further, are installed into the storage unit 1008, and are loaded into the RAM 1003 from the storage unit 1008. In the RAM 1003, further, pieces of data and the like necessary for the CPU 1001 to executes the various processes are appropriately stored.

In addition, in this specification document, steps for describing processing procedures are configured to, as a matter of course, include processes which are executed in time series in accordance with a described sequence order, and further, include processes which are not necessarily executed in time series but are executed in parallel or individually.

The present application contains subject matter related to that disclosed in Japanese Priority Patent Application JP 2009-177580 filed in the Japan Patent Office on Jul. 30, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus which performs setting of a mixture model function representing a mixture model along with adaptively adjusting the number of mixture model components included in the mixture model, the information processing apparatus comprising:
acquisition means for acquiring a first data sample and a second data sample, both of which are composed of multi-dimensions;
mixture-model-function generation means for generating a mixture model function on the basis of the first data sample;
mixture-model-function goodness-of-fit calculation means for calculating a goodness of fit for the mixture model function on the basis of the second data sample; and
mixture-model-function update means for updating the mixture model function so as to adjust the number of model components mixed in a mixture model, which is represented by the mixture model function, on the basis of the goodness of fit for the mixture model function.

2. The information processing apparatus according to claim 1, further comprising:
goodness-of-fit determination means for determining whether the goodness of fit for the mixture model function having been updated is within an allowable range or not, by comparing a goodness of fit for the mixture model function having been updated by the mixture-model-function update means and a goodness of fit for the mixture model function before being updated,
wherein, if it is determined by the goodness-of-fit determination means that the goodness of fit for the mixture model function having been updated is not within the allowable range, the mixture-model-function update means further updates the mixture model function.

3. The information processing apparatus according to claim 1,
wherein the mixture-model-function generation means generates the mixture model function for the second data sample, in addition to the mixture model function for the first data sample, and
wherein the mixture-model-function goodness-of-fit calculation means calculates the goodness of fit on the basis of likelihoods corresponding to respective mixture model functions for the first data sample and the second data sample.

4. The information processing apparatus according to claim 1, wherein the mixture-model-function update means for updating the mixture model function so as to perform adjustment of the number of model components by splitting data forming a model component having the largest eigenvalue among the model components mixed in the mixture model represented by the mixture model function.

5. The information processing apparatus according to claim 4, further comprising:
data inner product calculation means for obtaining a data inner product by calculating an inner product between each piece of data, which is included in the first data sample and forms a model component having the largest eigenvalue among model components which are mixed in the mixture model represented by the mixture model function, and an eigenvector for the each piece of data which forms the model component having the largest eigenvalue; and
average inner product calculation means for obtaining an average inner product by calculating an inner product between an average vector obtained from each piece of data, which is included in the first data sample and forms a model component having the largest eigenvalue among model components which are mixed in the mixture model represented by the mixture model function, and an eigenvector for the each piece of data which forms the model component having the largest eigenvalue,
wherein the mixture-model-function update means updates the mixture model function so as to perform adjustment of the number of model components by splitting the pieces of data forming the model component having the largest eigenvalue into two portions thereof in accordance with a magnitude relation between the data inner product and the average inner product.

6. The information processing apparatus according to claim 1,
wherein the mixture-model-function goodness-of-fit calculation means calculates a goodness of fit for each of model-function components forming the mixture model function, and
wherein the mixture-model-function update means performs adjustment for model-function components having a relatively low goodness of fit among the goodnesses of fit for each of the model-function components.

7. An information processing method, in which a mixture model function representing a mixture model is set along with adaptively adjusting the number of mixture model components included in the mixture model, the information processing method comprising the steps of:
acquiring a first data sample and a second data sample, both of which are composed of multi-dimensions;
generating a mixture model function on the basis of the first data sample;
calculating a goodness of fit for the mixture model function on the basis of the second data sample; and
updating the mixture model function so as to adjust the number of model components mixed in a mixture model, which are represented by the mixture model function, on the basis of the goodness of fit for the mixture model function.

8. A program causing a computer, which performs control so as to cause an information processing apparatus to perform setting of a mixture model function representing a mixture model along with adaptively adjusting the number of mixture model components included in the mixture model, to execute processing comprising the steps of:
acquiring a first data sample and a second data sample, both of which are composed of multi-dimensions;
generating a mixture model function on the basis of the first data sample;
calculating a goodness of fit for the mixture model function on the basis of the second data sample; and
updating the mixture model function so as to adjust the number of model components mixed in a mixture model, which are represented by the mixture model function, on the basis of the goodness of fit for the mixture model function.

9. An information processing apparatus which performs setting of a mixture model function representing a mixture model along with adaptively adjusting the number of mixture model components included in the mixture model, the information processing apparatus comprising:
an acquisition section configured to acquire a first data sample and a second data sample, both of which are composed of multi-dimensions;
a mixture-model-function generation section configured to generate a mixture model function on the basis of the first data sample;
a mixture-model-function goodness-of-fit calculation section configured to calculate a goodness of fit for the mixture model function on the basis of the second data sample; and
a mixture-model-function update section configured to update the mixture model function so as to adjust the number of model components mixed in a mixture model, which are represented by the mixture model function, on the basis of the goodness of fit for the mixture model function.
